(19) United States
(12) Patent Application Publication
(10) Pub. No.: US 2007/0175922 A1
(43) Pub. Date: Aug. 2, 2007

(54) Dispenser device

(76) Inventor: Young Chul Choi, Incheon (KR)

Correspondence Address: IPLA P.A., 3580 WILSHIRE BLVD., 17TH FLOOR, LOS ANGELES, CA, 90010, US

(21) Appl. No.: 10/598,715

(22) PCT Filed: Mar. 10, 2005
(86) PCT No.: PCT/KR05/00671

§ 371 Date: Sep. 8, 2006

(30) Foreign Application Priority Data
Mar. 10, 2004 (KR) 20-2004-0006462

(51) Int. Cl. B67D 5/60

(52) U.S. Cl. 222/145.2

(57) ABSTRACT

The invention relates to a dispenser device which may convert water into silver ionized water and may dispense the silver ionized water to necessary part of human body which may be easily contaminated by germs like as the affected part so that the necessary part of human body may be sterilized and the human body may be kept healthy. According to an aspect of the invention, there is provided a dispenser device 1 comprising a container 30, a silver foam block 10 which is contained in the container 30, and a pumping unit 20 which is combined at the upper portion of the container 30.

### TECHNICAL FIELD

The invention relates to a dispenser device, more particularly, relates to a dispenser device which may change water into silver ionized water

and may dispense the silver ionized water to necessary part of human body which may be easily contaminated by germs like as the affected part so that the necessary part of human body may be sterilized and the human body may be kept healthy.

### BACKGROUND OF THE INVENTION

Previously, a dispenser device has been disclosed that may dispense activated water by ceramic and etc. The dispenser device dispenses activated water and sterilizes necessary part of human body which may be easily contaminated by bacteria like as the affected part. However, the prior dispense device could not acquire high effect because sterilizing power of activated water is so weak. Further, the prior dispense device has a disadvantage that harmful bacteria may be bred in the inner space if the dispenser device is not used for a long time. In this case, the dispense device may cause various skin troubles owing to harmful bacteria contrary to the purpose for contributing to the health of the human body.

### SUMMARY OF THE INVENTION

The invention is created to solve the above described problems and so the object of the invention is to provide a dispense device which may change water into silver ionized water and may dispense the silver ionized water to necessary part of human body which may be easily contaminated by germs like as the affected part so that the necessary part of human body may be sterilized and the human body may be kept healthy.

According to an aspect of the invention, there is provided a dispenser device comprising:

a container 30;

a silver foam block 10 which has is contained in the container 30;

and a pumping unit 20 which is combined at the upper portion of the container 30;

and wherein the water filled in the container 30 may be changed into silver ionized water by the silver foam block 10 and may be dispensed through the pumping unit 20.

### BRIEF DESCRIPTION OF THE DRAWINGS

FIG. 1 is a dissembled view of the invention.

FIG. 2 is a perspective view of the invention.

### DETAILED DESCRIPTION OF THE INVENTION

A preferred embodiment of the invention will be described in detail below by referring to the accompanying drawings.

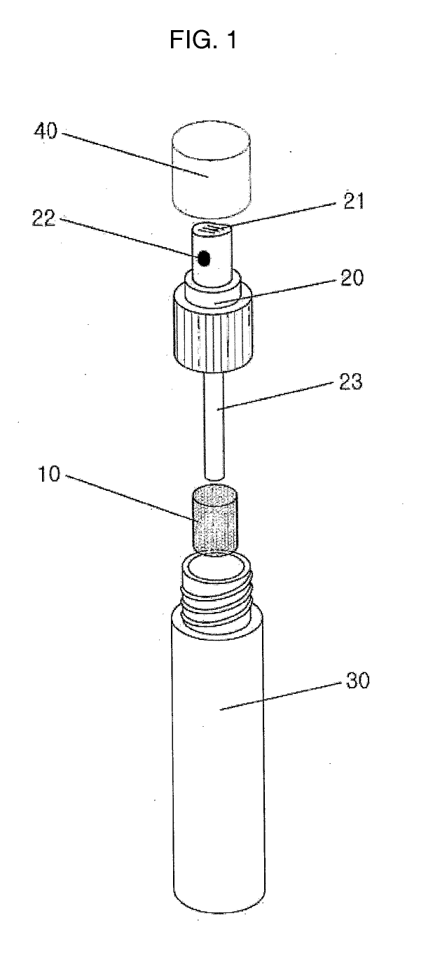

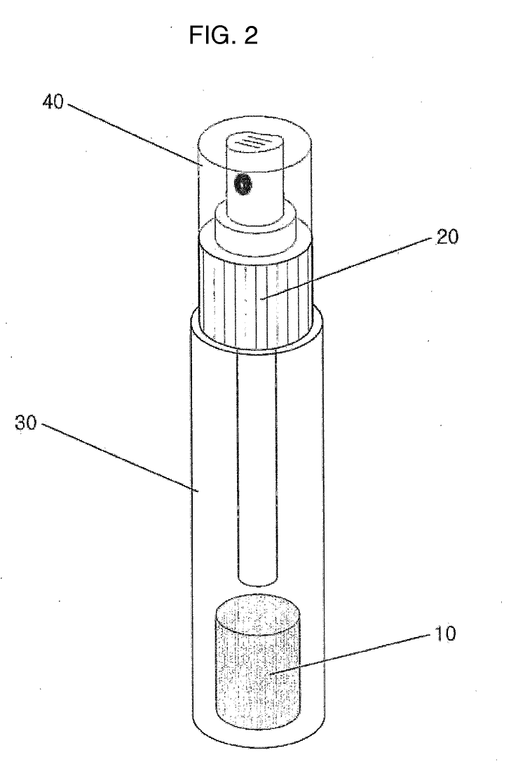

FIG. 1 is a dissembled view of the invention, and FIG. 2 is a perspective view of the invention. As shown in the drawings, the invention comprises a container 30, a silver foam block 10 and a pumping unit 20.

The container 30 is formed in long bottle shape and water is contained in the inner space. The container is made of transparent resin. And, a silver foam block 10 is contained in the bottom of the container 30. The silver foam block 10 is formed in a porous block type to have a plurality of holes therein. Accordingly, the water in the container 30 may be changed into silver ionized water by the silver foam block 10.

The pumping unit 20 includes a cap 25, a tube 23 and a push button 21. The cap 25 is combined at the periphery of the upper portion of the container 30 in screw type. The tube 23 is extended downwardly from the cap 25. The push button 21 has a hole 22 which is connected to the tube 23. And, the push button 21 is liftably provided at the top of the cap 25. Accordingly, if the push button 21 is pushed downwardly, the silver ionized water in the container 30 may be pumped upwardly through the tube 23 and may be dispensed outwardly through the hole 11 of the push button 21. And, And, reference number 40 of FIG. 1 and FIG. 2 is over cap.

According to the invention as described above, the water filled in the container 30 may be changed into silver ionized water by the silver foam block 10 and the silver ionized water may be dispensed to the affected part of human body and so on when a user pushes the push button 21. And, the silver ionized water dispensed by the invention may sufficiently sterilize the affected part and so on.

Here, the invention may be used for animals or plants and may acquire the same effect.

### INDUSTRIAL APPLICABILITY

According to the above-described invention, the invention has a silver foam block which is container in the container, the water in the container is changed into silver ionized water by the silver foam block and the silver ionized water may be dispensed to necessary part of human body. Accordingly, the invention may sufficiently sterilize the necessary part of the human body which may be easily contaminated by harmful bacteria like as the affected part so that it may contribute the health of the human body.

Particularly, the invention may help the abrasion or the wound after operation and so on to be quickly healed without becoming worse.

1. A dispenser device comprising:
a container 30;
a silver foam block 10 which has is contained in the container 30;
and a pumping unit 20 which is combined at the upper portion of the container 30;
and wherein the water filled in the container 30 may be changed into silver ionized water by the silver foam block 10 and may be dispensed through the pumping unit 20.
